(19) United States
(12) Patent Application Publication
(10) Pub. No.: US 2021/0055714 A1
(43) Pub. Date: Feb. 25, 2021

(54) Method and system for estimating ecological influence of textile fabric production

(71) Applicant: The Hong Kong Research Institute of Textiles and Apparel Limited, Hong Kong (CN)

(72) Inventors: Lei YAO, Hong Kong (CN); Xiao LIAO, Hong Kong (CN)

(21) Appl. No.: 15/733,590

(22) PCT Filed: Mar. 9, 2018
(86) PCT No.: PCT/CN2018/078638

§ 371 Date: Nov. 12, 2020

(51) Int. Cl. G05B 19/418; G06Q 10/06; G06Q 10/00

(52) U.S. Cl. CPC G05B 19/41885; G05B 19/4183; G06Q 10/30; G06Q 10/06315; G06Q 10/06316; G05B 19/41865

(57) ABSTRACT

A method, system and computer-readable storage medium for estimating an ecological impact of textile fabric production are provided. The ecological impact comprises a natural environmental impact. The method comprises: inputting composition of a textile fabric and a name of region where one or more steps of the textile fabric production are implemented; calling corresponding data from a database according to the input composition and the input name of region; and obtaining a score of the natural environment impact for the one or more steps of the textile fabric production according to a predetermined first operational rule and the data.

### TECHNICAL FIELD

The present invention relates to the field of assessments of ecological impact, and more particularly, to a method, system and computer-readable storage medium for estimating an ecological impact of textile fabric production.

### BACKGROUND

Currently, textile fabrics are widely applied to various fields. However, production of the textile fabric may have significant impact on the ecological environment (for example, carbon emission, or the like). Therefore, how to reduce the impact of textile production on the ecological environment is one of the problems required to be solved urgently in the textile industry. Generally, production work of a textile-fabric production enterprise is arranged according to requirements of a brand marketing enterprise, and selection of raw materials by the brand marketing enterprise and the region of the production enterprise largely determine the possible impact on the ecological environment in the production process. In the related art, a prior art mainly includes prediction and assessment of the ecological impact of products made of different raw materials, as well as evaluation of the ecological impact in the production process of different manufacturers. However, there is no related technology for an auxiliary system for estimating the ecological impact of the textile fabric production at a product design stage before the production.

In addition to the ecological impact of the raw materials and the regionality of the production enterprise on the textile fabric production, production technology flow has significant ecological impact on the textile fabric production. The production technology flow of the textile fabric is required to include a plurality of steps of raw material production, fiber production, yarn production, fabric production, fabric dyeing, finishing, or the like. Since each step of the textile fabric production may be implemented at different places around the world, it is very complicated and difficult to assess the ecological impact of the whole production flow of a product, such that currently, the assessment of the ecological impact of the production technology flow by the manufacturer is only able to involve part of the production process, and a unified assessment is unable to be performed on the ecological impact of the whole production flow (including the whole life cycle from raw material production to product recycling) of the product.

Furthermore, in the process of assessing the ecological impact of the textile fabric production on the natural environment, how to integrate different affecting factors has been a difficulty in the industry since the natural environment impact of different affecting factors in each step is unable to be obtained by calculating an average value in a simple addition or subtraction way. The importance of each step for the overall impact on the ecological environment is also required to be considered during unification of each step into an overall impact assessment result. Therefore, how to design suitable operation rules and weights is an urgent problem to be solved.

Furthermore, the ecological impact of the textile fabric production includes not only the natural environment impact, but also human society impact and animal right impact. The prior art only has the assessment of the natural environment impact of part of the production process of a single manufacturer for producing the textile fabric, and does not cover the assessment of the human society impact and animal right impact.

### SUMMARY OF THE INVENTION

Therefore, the present invention is intended to solve one or more of the above-mentioned technical problems.

The present invention provides method and system for objectively estimating an ecological impact of textile fabric production for different raw materials and different production regions.

The present invention relates to a method for estimating an ecological impact of textile fabric production, the ecological impact comprises a natural environment impact, the method comprises: inputting composition of a textile fabric and a name of region where one or more steps of the textile fabric production are implemented; calling corresponding data from a database according to the input composition and the name of region; and obtaining a score of the natural environment impact of the one or more steps of the textile fabric production according to a predetermined first operational rule and the data.

Preferably, the method according to the present invention further comprises: determining a comprehensive score of the natural environment impact of the textile fabric production from the obtained scores of the natural environment impact of the plural steps according to a predetermined second operational rule.

Preferably, the first operational rule in the method according to the present invention comprises a formula EIᵢ=Σ(GW+WW+WC+EC+CM+SW), wherein EIᵢ denotes the score of the natural environment impact of the ith step, GW denotes a greenhouse-gas score item, WW denotes a wastewater score item, WC denotes a water score item, EC denotes an energy-consumption score item, CM denotes a chemical-consumption score item, SW denotes a solid-waste score item; wherein the score of the natural environment impact of the ith step is a weighted average of the score items.

Preferably, the second operational rule in the method according to the present invention comprises a formula EI₀=Σᵢ₌₁⁷EIᵢ, wherein EI₀ denotes the comprehensive score of the natural environment impact, EI₁ denotes a raw-material-production-step score item, EI₂ denotes a fiber-production-step score item, EI₃ denotes a yarn-production-step score item, EI₄ denotes a fabric-production-step score item, EI₅ denotes a dyeing-step score item, EI₆ denotes a finishing-step score item, and Eh denotes a recycling-step score item.

Preferably, the first operational rule in the method according to the present invention further comprises selecting a set of predetermined weights consisting of (δₙ, n=1,2,3,4,5,6) to be applied to the score terms in the formula of the first operational rule respectively, wherein δₙ ranges from 0.1 to 2.0.

Preferably, the second operational rule in the method according to the present invention further comprises selecting a set of predetermined weights consisting of (θₙ, n=1,2,3,4,5,6,7) to be applied to the score terms in the formula of the second operational rule respectively, wherein θₙ ranges from 0.1 to 2.0.

Preferably, the ecological impact in the method according to the present invention further comprises a human society impact and/or an animal right impact.

Preferably, the method according to the present invention further comprises a step of estimating the human society impact, the step including: calling a corresponding report in the database according to the input name of region, and outputting a title of the corresponding report as an estimation result.

Preferably, the estimation result of the human society impact in the method according to the present invention comprises employee treatment, career development and training, medical security, a working environment, occupational safety, community services and transparency.

Preferably, the method according to the present invention further comprises a step of estimating the animal right impact, the step including: calling a corresponding report in the database according to the input name of region, and outputting a title of the corresponding report as an estimation result.

Preferably, the estimation result of the animal right impact in the methods according to the present invention comprises an animal experiment and animal abuse.

Preferably, when the corresponding data is not called from the database, an average of all regions is used to replace the missing data.

Preferably, before the data is substituted into the formula of the first operational rule for calculation, the data is standardized.

Preferably, the method according to the present invention further comprises: converting the obtained comprehensive score of the natural environment impact into a standard score.

Preferably, the database contains data of the ecological impact of each step of the textile fabric production at different regions and may be updated via a network server.

Preferably, the textile fabric comprises a textile fabric made of a single raw material and a textile fabric mixed of a plurality of raw materials.

Preferably, the production steps in the method according to the present invention comprise a raw material production step, a fiber production step, a yarn production step, a fabric production step, a dyeing step, a finishing step and a recycling step.

The present invention further relates to a system for estimating an ecological impact of textile fabric production, the ecological impact comprises natural environment impact, the system comprises: an input module for inputting composition of a textile fabric and a name of region where one or more steps of the textile fabric production are implemented; a processor configured to perform the following operation: calling corresponding data from a database according to the input composition and the input name of region, and performing an operation according to a predetermined first operational rule and the data, so as to obtain a score of the natural environment impact of the one or more steps of the textile fabric production; and an output module for outputting the score of the natural environment impact.

Preferably, the processor in the system according to the present invention is further configured to perform a predetermined second operational rule, and determine a comprehensive score of the natural environment impact of the textile fabric production from the obtained scores of the natural environment impact of the plural steps; the output module is further configured to output the comprehensive score of the natural environment impact.

Preferably, the first operational rule comprises a formula EIᵢ=Σ(GW+WW+WC+EC+CM+SW), wherein EIᵢ denotes the score of the natural environment impact of the ith step, GW denotes a greenhouse-gas score item, WW denotes a wastewater score item, WC denotes a water score item, EC denotes an energy-consumption score item, CM denotes a chemical-consumption score item, SW denotes a solid-waste score item, and the score of the natural environment impact of the ith step is a weighted average of the score items.

Preferably, the second operational rule comprises a formula EI₀=Σᵢ₌₁⁷EIᵢ, wherein EI₀ denotes the comprehensive score of the natural environment impact, EI₁ denotes a raw-material-production-step score item, EI₂ denotes a fiber-production-step score item, EI₃ denotes a yarn-production-step score item, EI₄ denotes a fabric-production-step score item, EI₅ denotes a dyeing-step score item, EI₆ denotes a finishing-step score item, and Eh denotes a recycling-step score item.

Preferably, the first operational rule further comprises selecting a set of predetermined weights consisting of (δₙ, n=1,2,3,4,5,6) to be applied to the score terms in the formula of the first operational rule respectively, wherein δₙ ranges from 0.1 to 2.0.

Preferably, the second operational rule further comprises selecting a set of predetermined weights consisting of (θₙ, n=1,2,3,4,5,6,7) to be applied to the score terms in the formula of the second operational rule respectively, wherein θₙ ranges from 0.1 to 2.0.

Preferably, the ecological impact further comprises a human society impact and/or an animal right impact.

Preferably, the processor in the system according to the present invention is further configured to perform the operation of estimating the human society impact, the operation of estimating the human society impact including: calling a corresponding report in the database according to the input name of region, and outputting a title of the corresponding report as an estimation result.

Preferably, the estimation result of the human society impact comprises employee treatment, career development and training, medical security, a working environment, occupational safety, community services and transparency.

Preferably, the processor in the system according to the present invention is further configured to perform the operation of estimating the animal right impact, the operation of estimating the animal right impact including: calling a corresponding report in the database according to the input name of region, and outputting a title of the corresponding report as an estimation result.

Preferably, the estimation result of the animal right impact comprises an animal experiment and animal abuse.

Preferably, when the corresponding data is not called from the database, an average of all regions is used to replace the missing data.

Preferably, before the data is substituted into the formula of the first operational rule for calculation, the data is standardized.

Preferably, the processor in the system according to the present invention is further configured to convert the obtained comprehensive score of the natural environment impact into a standard score.

Preferably, the database contains data of the ecological impact of each step of the textile fabric production at different regions and may be updated via a network server.

Preferably, the textile fabric comprises a textile fabric made of a single raw material and a textile fabric mixed of a plurality of raw materials.

Preferably, the production steps comprise a raw material production step, a fiber production step, a yarn production step, a fabric production step, a dyeing step, a finishing step and a recycling step.

The present invention further relates to a computer-readable storage medium with computer instructions stored thereon, characterized in that the computer instructions, when executed by the processor, implement the following steps: calling corresponding data from a database according to input composition of a textile fabric and a name of region where one or more steps of textile fabric production are implemented; and obtaining a score of natural environment impact of the one or more steps of the textile fabric production according to a predetermined first operational rule and the data.

Preferably, the instructions, when executed by the processor, further implement the following steps: performing an operation according to a predetermined second operational rule; and determining a comprehensive score of the natural environment impact of the textile fabric production from the obtained scores of the natural environment impact of the plural steps.

Preferably, the first operational rule comprises a formula EIᵢ=Σ(GW+WW+WC+EC+CM+SW), wherein EIᵢ denotes the score of the natural environment impact of the ith step, GW denotes a greenhouse-gas score item, WW denotes a wastewater score item, WC denotes a water score item, EC denotes an energy-consumption score item, CM denotes a chemical-consumption score item, SW denotes a solid-waste score item, and the score of the natural environment impact of the ith step is a weighted average of the score items.

Preferably, the second operational rule comprises a formula EI₀=Σᵢ₌₁⁷EIᵢ, wherein EI₀ denotes the comprehensive score of the natural environment impact, EI₁ denotes a raw-material-production-step score item, EI₂ denotes a fiber-production-step score item, EI₃ denotes a yarn-production-step score item, EI₄ denotes a fabric-production-step score item, EI₅ denotes a dyeing-step score item, EI₆ denotes a finishing-step score item, and Eh denotes a recycling-step score item.

Preferably, the first operational rule further comprises selecting a set of predetermined weights consisting of (δₙ, n=1,2,3,4,5,6) to be applied to the score terms in the formula of the first operational rule respectively, wherein δₙ ranges from 0.1 to 2.0.

Preferably, the second operational rule further comprises selecting a set of predetermined weights consisting of (θₙ, n=1,2,3,4,5,6,7) to be applied to the score terms in the formula of the second operational rule respectively, wherein θₙ ranges from 0.1 to 2.0.

Preferably, the ecological impact further comprises a human society impact and/or an animal right impact.

Preferably, the instructions, when executed by the processor, further implement the step of estimating the human society impact, the step of estimating the human society impact including: calling a corresponding report in the database according to the input name of region, and outputting a title of the corresponding report as an estimation result.

Preferably, the instructions, when executed by the processor, further implement the step of estimating the animal right impact, the step of estimating the animal right impact including: calling a corresponding report in the database according to the input name of region, and outputting a title of the corresponding report as an estimation result.

On the one hand, with the method and system for estimating the ecological impact of the textile fabric production according to the present invention, the corresponding data may be found in the database according to different raw materials and production regions, and the ecological impact of the textile fabric production may be objectively estimated with the predetermined algorithm, such that a user may be assisted in considering the ecological impact of a product at a product design stage to select appropriate raw materials and production regions.

On the other hand, with the method and system for estimating the ecological impact of the textile fabric production according to the present invention, the ecological impact of the textile fabric in the whole life cycle including each production step and recycling may be assessed with an appropriate predetermined algorithm, such that the user may estimate the ecological impact more comprehensively.

In yet another aspect, with a large number of experiments and calculations, the method and system for estimating the ecological impact of the textile fabric production according to the present invention adopt appropriate and accurate weights, such that different affecting factors and production steps may be integrated when the ecological impact is estimated, thereby obtaining the ecological impact which is objective and relatively quantitative.

Furthermore, with the method and system for estimating the ecological impact of the textile fabric production according to the present invention, not only the natural environment impact, but also the human society impact and the animal right impact may be estimated, thereby providing a more comprehensive assessment of the ecological impact for the user.

### BRIEF DESCRIPTION OF THE DRAWINGS

The technical solution of the present invention may be better understood with accompanying drawings and the following description, in which:

FIG. 1 shows a flow chart of a method for estimating an ecological impact of textile fabric production according to an exemplary embodiment of the present invention; and

FIG. 2 shows a schematic diagram of a system for estimating an ecological impact of textile fabric production according to an exemplary embodiment of the present invention.

### DETAILED DESCRIPTION OF THE EMBODIMENTS

In order to make the objects, technical solutions and advantages of the present invention clearer, the present invention will be further described in detail below in combination with embodiments. It should be understood that, the embodiments described herein are only intended to illustrate but not to limit the present invention.

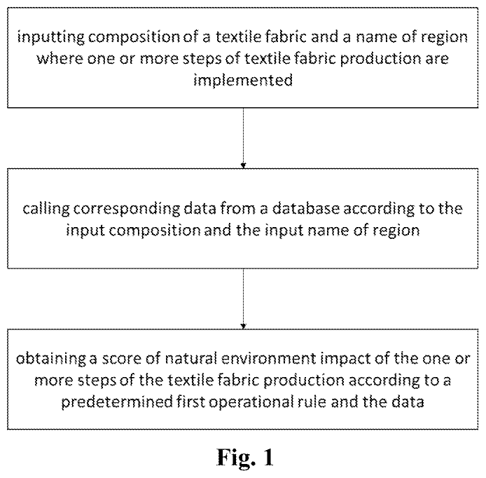

As shown in FIG. 1, a method for estimating natural environment impact of textile fabric production according to the present invention comprises the following steps.
Step 1: inputting composition of a textile fabric and a name of region where one or more steps of the textile fabric production are implemented, wherein the textile fabric may be a textile fabric made of a single raw material, a textile fabric mixed of a plurality of raw materials or other textile fabrics, and the region where the one or more steps of the textile fabric production are implemented may be a country or district where the one or more steps of the textile fabric production are implemented, and the ecological impact generated by the textile fabric production in different countries or districts may be obviously different due to different production technical levels and environmental protection requirements of various countries or districts.
Step 2: calling corresponding data from a database according to the input composition and the name of region. The data in the database may come from industrial, environmental and human statistical data of various districts/countries; reports from international organizations (for example, WHO, UN, WTO, OECD), such as Global Greenhouse Gas Emissions Data issued by a USA environmental protection organization; reports from non-governmental agencies (for example, environmental protection and right agencies), such as Flawed Fabrics The abuse of girls and women workers in the South Indian textile industry, published by the Centre for Research on Multinational Corporations and the Indian Committee of the Netherlands; academic reports/articles, such as Animal Ethics and Welfare in the Fashion and Lifestyle Industries, published by Green Fashion on Jan. 23, 2016, pp 49-122; reports (child labor, animal treatment, or the like), such as an adverse behavior toward sheep in a wool clipping process reported by nbcnews on Jul. 8, 2004; related data of business entities, or the like. The collected data is formed into a standard-order numeric matrix. The standard-order numeric matrix which may be used in the present invention may be obtained in various ways known in the art. In one example, the collected data is sorted in an increasing order to form a standard-order numeric matrix (for example, a numeric matrix from 0 to 100) corresponding to the numerical order of the collected data; the data may be standardized using the standard-order numeric matrix; that is, according to the input raw material and the name of country or region, corresponding standard data may be found from the standard-order numeric matrix, for example, corresponding ordinal values in the standard-order numeric matrix. For example, when the input raw material and name of country or district are cotton and China, in order to obtain the standard data corresponding to greenhouse gas in a raw material production step, if the system according to the present invention finds the ranking position of the standard data in the matrix to be 5th from the database, the standard data is 5. The inventor collected and calculated data on greenhouse gas emission, wastewater, water, energy consumption, chemical consumption and solid waste in the processes of cotton planting, picking, spinning, weaving, bleaching, dyeing and finishing in countries, such as China, USA, India, Pakistan, or the like, so as to obtain all data on each factor of different steps in different countries, thereby establishing the database. The database may be updated irregularly or regularly via a network server; when the corresponding data is not called from the database, an average of all the regions may be adopted to replace the missing data.
Step 3: obtaining a score of the natural environment impact of the one or more steps of the textile fabric production according to a predetermined first operational rule and the data called from the database. The first operational rule comprises a formula (1) EIᵢ=Σ(GW+WW+WC+EC+CM+SW), wherein EIᵢ denotes the score of the natural environment impact of the ith step, GW denotes a greenhouse gas score item, WW denotes a wastewater score item, WC denotes a water score item, EC denotes an energy consumption score item, CM denotes a chemical-consumption score item, and SW denotes a solid waste score item. Preferably, a set of predetermined weighted weights (δₙ, n=1,2,3,4,5,6) is selected to be applied to each score item in the formula (1) of the first operational rule respectively, so as to optimize the score of the natural environment impact of each step in the production.

Preferably, the method for estimating the natural environment impact of the textile fabric production according to the present invention further comprises step 4, that is, determining a comprehensive score of the natural environment impact of the textile fabric production from the obtained scores of the natural environment impact of the plural steps according to a predetermined second operational rule. The second operational rule comprises a formula (2) EI₀=Σᵢ₌₁⁷EIᵢ, wherein EI₀ denotes the comprehensive score of the natural environment impact, EI₁ denotes a raw material production step score item, EI₂ denotes a fiber production step score item, EI₃ denotes a yarn production step score item, EI₄ denotes a fabric production step score item, EI₅ denotes a dyeing step score item, EI₆ denotes a finishing step score item, and EI₇ denotes a recycling step score item. Preferably, a set of predetermined weights (θₙ, n=1,2,3,4,5,6,7) is selected to be applied to each score item in the formula (2) of the second operational rule respectively, so as to optimize the comprehensive score of the natural environment impact. Preferably, the obtained comprehensive score of natural environmental impact is converted into a standard score, for example, by standardizing the maximum and minimum values of the obtained data among countries.

The method for estimating the ecological impact of the textile fabric production according to the present invention not only may comprise the method for estimating the natural environment impact, but also further comprises estimating a human society impact and an animal right impact. Herein, estimating the human society impact in the present invention may comprise: calling a corresponding report in the database according to the input name of region, and outputting a title of the corresponding report as an estimation result. Estimating the animal right impact in the present invention may comprise: calling a corresponding report in the database according to the input name of region, and outputting a title of the corresponding report as an estimation result. Since various factors in the human society impact and the animal right impact are difficult to calculate quantitatively and are unable to be calculated directly with the operational rule, thus, the present invention predetermine appropriate weights according to the importance of each factor in the human society impact and the animal right impact, such that an assessment result of the factor with a high weight is displayed in the above-mentioned output report preferentially, and thus, a user may conveniently perform an assessment more efficiently. Herein, the estimation result of the human society impact may comprise employee treatment, career development and training, medical security, working environment, occupational safety, community services and transparency; the estimation result of the animal right impact may comprise animal experiments, animal abuse and other inhuman animal treatment behaviors.

It should be noted that, in the art, it is difficult to select appropriate weights, the importance of different affecting factors (i.e., the above-mentioned score items) is required to be considered, and by applying appropriate weights to different affecting factors, an assessment result of the ecological impact which is more objective and accurate is obtained. For the natural environment impact, the weight is used as a weighted average factor in the formulas of the first and second operational rules to calculate a weighted average. For the human society impact and the animal right impact, the weight represents the importance of each factor in the output report, and the factor with a high weight is displayed preferentially. In the present invention, for each factor, the selected weight ranges from 0.1 to 2.0, wherein 0.1 represents the factor which is least important, and 2.0 represents the factor which is most important, that is, a larger value represents a higher importance. In the present invention, the preferred range of the weight of each factor is obtained with a large number of experiments and calculations.

The preferred ranges of the weights (δₙ, n=1,2,3,4,5,6) of the score items in the formula (1) of the first operational rule comprise: the weight δ₁ of the greenhouse-gas score item: 0.79-1.62; the weight δ₂ of the wastewater score item: 0.55-1.23; the weight δ₃ of the water score item: 0.72-1.31; the weight δ₄ of the energy-consumption score item: 0.59-1.45; the weight δ₅ of the chemical-consumption score item: 0.72-1.20; the weight δ₆ of the solid-waste score item: 0.68-1.24. More preferably, the ranges of the weights (δₙ, n=1,2,3,4,5,6) of the score items in the formula (1) may comprise: the weight δ₁ of the greenhouse gas score item: 1.05-1.30; the weight δ₂ of the wastewater score item: 0.75-1.05; the weight δ₃ of the water score item: 0.90-1.10; the weight δ₄ of the energy consumption score item: 0.80-1.20; the weight δ₅ of the chemical consumption score item: 0.95-1.10; the weight δ₆ of the solid-waste score item: 0.89-1.08.

The preferred ranges of the weights (θₙ, n=1,2,3,4,5,6,7) of the score items in the formula (2) of the second operational rule comprise: the weight θ₁ of the raw material production step: 0.61-1.89; the weight θ₂ of the fiber production step: 0.61-1.20; the weight θ₃ of the yarn production step: 0.28-1.20; the weight θ₄ of the fabric production step: 0.46-1.20; the weight θ₅ of the dyeing step: 0.74-1.85; the weight θ₆ of the finishing step: 0.80-1.51; and the weight θ₇ of the recycling step: 0.80-1.20. More preferably, the ranges of the weights (θₙ, n=1,2,3,4,5,6,7) of the score items in the formula (2) may comprise: the weight θ₁ of the raw material production step: 1.05-1.50; the weight θ₂ of the fiber production step: 0.90-1.10; the weight θ₃ of the yarn production step: 0.60-0.90; the weight θ₄ of the fabric production step: 0.75-1.05; the weight θ₅ of the dyeing step: 1.05-1.45; the weight θ₆ of the finishing step: 1.05-1.25; the weight θ₇ of the recycling step: 0.90-1.10.

The preferred ranges of the weights for the factors of the human society impact comprise: the employee treatment: 0.80-2.00; the career development and training: 0.03-1.21; the medical security: 0.03-1.75; the working environment: 0.79-2.00; the occupational safety: 0.79-2.00; the community service: 0.10-1.34; the transparency: 0.10-1.27. The more preferred ranges of the weights for the factors of the human society impact comprise: the employee treatment: 1.20-1.60; the career development and training: 0.40-0.90; the medical security: 0.50-1.20; the working environment: 1.10-1.50; the occupational safety: 1.15-1.55; the community service: 0.45-0.90; the transparency: 0.45-0.85.

The preferred ranges of the weights of the factors of the animal right impact comprise: the animal experiment and animal abuse: 0.74-1.21; the others: 0.79-1.26. The more preferred ranges of the weights of the factors of the animal right impact may comprise: the animal experiment and animal abuse: 0.85-1.05; the others: 0.90-1.10. The total-score assessment result obtained with the method according to the present invention has the meanings as follows:
The comprehensive score of 0-20 indicates: among the fabrics covered by the present method, this fabric has little impact on the natural environment. The production of the fabric according to the selected raw materials and the selected production region of the steps has limited impact on the natural environment. According to the assessment result of the natural environment impact, it is strongly recommended to produce the fabric according to the selected raw materials and the selected production region of the steps.
The comprehensive score of 21-40 indicates: among the fabrics covered by the present method, this fabric has minor impact on the natural environment. The production of the fabric according to the selected raw materials and the selected production region of the steps has certain impact on the natural environment. According to the assessment result of the natural environment impact, it is recommended to produce the fabric according to the selected raw materials and the selected production region of the steps.
The comprehensive score of 41-60 indicates: among the fabrics covered by the present method, this fabric has medium impact on the natural environment. The production of the fabric according to the selected raw materials and the selected production region of the steps has general impact on the natural environment. According to the assessment result of the natural environment impact, it may or may not be recommended to produce the fabric according to the selected raw materials and the selected production region of the steps.
The comprehensive score of 61-80 indicates: among the fabrics covered by the present method, this fabric has large impact on the natural environment. The production of the fabric according to the selected raw materials and the selected production region of the steps has remarkable impact on the natural environment. According to the assessment result of the natural environment impact, it is not recommended to produce the fabric according to the selected raw materials and the selected production region of the steps.
The comprehensive score of 81-100 indicates: among the fabrics covered by the present method, the fabric has great impact on the natural environment. The production of the fabric according to the selected raw materials and the selected production region of the steps has serious impact on the natural environment. According to the assessment result of the natural environment impact, it is strongly not recommended to produce the fabric according to the selected raw materials and the selected production region of the steps.

For the preferred weight range and the scoring standard in the present invention, an expert team performs an open questionnaire assessment on the reliability of the weight and the scoring standard according to operation results. The expert team includes 5 university professors from Germany, Japan and China, 3 non-governmental organizations specializing in environmental-protection related projects, and 4 global textile garment companies. The assessment result affirms that the weight range in the present invention may be used as a reliable way for assessing the ecological impact comprehensively.

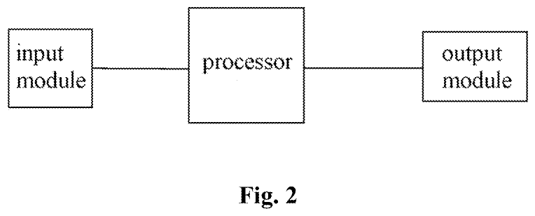

FIG. 2 shows a system for estimating an ecological impact of textile fabric production according to another aspect of the present invention, the system comprises an input module, a processor and an output module. Herein, the input module is configured to input composition of a textile fabric and a name of region where one or more steps of the textile fabric production are implemented. The processor is configured to perform the following operation: calling corresponding data from a database according to the input composition and the input name of region, and performing an operation according to a predetermined first operational rule and the data, so as to obtain a score of the natural environment impact of the one or more steps of the textile fabric production. The output module is configured to output the score of the natural environment impact.

Preferably, the processor in the system for estimating the ecological impact of the textile fabric production according to the present invention is further configured to perform a predetermined second operational rule, and determine a comprehensive score of the natural environment impact of the textile fabric production from the obtained scores of the natural environment impact of the plural steps; the output module is further configured to output the comprehensive score of the natural environment impact.

The present invention further relates to a computer-readable storage medium with computer instructions stored thereon, and the instructions, when executed by a processor, implement the above-mentioned steps of calling corresponding data from a database according to input composition and an input name of region; and obtaining a score of natural environment impact of the one or more steps of the textile fabric production according to a predetermined first operational rule and the data. Preferably, the instructions, when executed by the processor, further implement the following step: determining a comprehensive score of the natural environment impact of the textile fabric production from the obtained scores of the natural environment impact of the plural steps according to a predetermined second operational rule.

The computer-readable storage medium described herein may be a non-transitory computer-readable storage medium. By way of example, and without limitation, the computer-readable storage medium may include RAM, ROM, EEPROM, CD-ROM or other optical disk memories, magnetic disk memories or other magnetic storage devices, or any other medium which may be used to carry or store desired or computer-accessible program codes in the form of instructions or data structures. Combinations of the above-mentioned medium should also be included within the scope of the computer-readable storage medium.

The present invention is further described below by means of specific examples.

### Embodiment 1—Standardization of Data

The embodiment describes the process of standardizing data in the present invention in detail. The raw material in the embodiment is cotton, and the process of standardizing data of each factor of raw material production in China, USA, India and Pakistan is described.

The data called from the database according to the input name of the raw material and the raw material production step is shown in Table 1 below:

TABLE 1

| | | Cotton | | | |
|---|---|---|---|---|---|
| | | USA | China | India | Pakistan |
| Raw material | | Including irrigation, chemical applications and fuel use | | | |
| Greenhouse gas | | | | | |
| | kg | | | | |
| GWP (100a) | CO2 | 2.9800 | 11.3679 | 2.2538 | 3.1956 |
| | eq./kg | | | | |
| CH4 | kg/kg | 0.0076 | 0.0061 | — | — |
| N2O/NOx | kg/kg | 0.0227 | 0.0061 | 0.0684 | 0.2330 |
| SO2 | kg/kg | 0.0040 | — | 0.0393 | — |
| Others | | | | | |
| CH | kg/kg | 0.0050 | — | — | — |
| COD | kg/kg | 0.0161 | 0.0003 | — | — |
| PO4 | kg/kg | — | — | — | 0.0543 |
| PMs | kg/kg | — | 0.0015 | 0.0217 | — |

Values corresponding to the greenhouse gas are taken as an example in Table 1. Values of other factors, such as wastewater, water, energy consumption, chemical consumption, or the like, may be processed similarly.

Then, the obtained data is standardized, that is, the called data corresponds to the standard-order numeric matrix, thereby finding out the corresponding standard data (i.e., the ordinal value of the position in the matrix), as shown in the following Table 2:

TABLE 2

| | Cotton | | | |
|---|---|---|---|---|
| | USA | China | India | Pakistan |
| | Including irrigation, chemical applications and fuel use | | | |
| Greenhouse gas | 13 | 50 | 10 | 14 |
| Water | 43 | 100 | 100 | 91 |
| Wastewater | 0 | 0 | 0 | 0 |
| Chemical consumption | 1 | 1 | 1 | 1 |
| Energy consumption | 14 | 13 | 23 | 6 |

Table 2 exemplarily shows the standardized values of the factors of greenhouse gas, water, wastewater, chemical consumption and energy consumption in the raw material production step in USA, China, India and Pakistan with cotton as the raw material. After collected, the data of all the raw materials and the factors of all the production steps in all the countries where the data is collected is sorted in the increasing order to form the standard-order numeric matrix corresponding to the numerical order of the collected data, and the data may be standardized using the standard-order numeric matrix with the above-mentioned steps.

### Embodiment 2—Natural Environmental Impact

In order to more clearly show the process of a method for obtaining the ecological impact in the present invention, the weights in the formula (1) of the first operational rule and the formula (2) of the second operational rule are set to 1.0 in the embodiment 2, and specific calculation steps are as follows.

The input raw material is: 100% organic cotton; the production countries or districts of each step are as follows: raw materials production-USA; fiber production-USA; yarn production-China; fabric production-China; dyeing-China; finishing-China; recycling-China.

The data called from the database according to the input name of the raw material and the input production countries of each step are shown in Table 3:

TABLE 3
Natural environment impact

| | Total | Green-house | Waste | | Energy | Chemical | Solid |
|---|---|---|---|---|---|---|---|
| Production flow | score | gas | water | Water | consumption | consumption | waste |
| Raw material production | n/a | 2.7000 | 0.0112 | 68.0737 | 4.7007 | 0.0000 | 0.9093 |
| Fiber production | n/a | 0.1110 | 0.0000 | 0.0000 | 0.0000 | 0.1583 | 1.7000 |
| Yarn production | n/a | 4.0800 | 0.0000 | 0.0000 | 3.4900 | 0.0000 | 0.1820 |
| Fabric production | n/a | 0.9876 | 0.0000 | 0.0000 | 0.1080 | 0.0000 | 0.0220 |
| Dyeing | n/a | 1.5049 | 43.0000 | 46.7500 | 0.7331 | 1.5443 | 0.4883 |
| Finishing | n/a | 0.2624 | 0.4625 | 0.9140 | 0.3081 | 0.0625 | 0.0000 |
| Recycling | n/a | n/a | n/a | n/a | n/a | n/a | n/a |
| Overall | n/a | n/a | n/a | n/a | n/a | n/a | n/a |

Results of standardization of the scores in Table 3 are shown in the following Table 4.

TABLE 4
Natural environment impact

| | Total | Green-house | Waste | | Energy | Chemical | Solid |
|---|---|---|---|---|---|---|---|
| Production flow | score | gas | water | Water | consumption | consumption | waste |
| Raw material production | | 12 | 3 | 10 | 0 | 0 | 14 |
| Fiber production | | 1 | 0 | 0 | 0 | 0 | 1 |
| Yarn production | | 18 | 0 | 0 | 2 | 0 | 10 |
| Fabric production | | 5 | 0 | 0 | 1 | 0 | 1 |
| Dyeing | | 7 | 2 | 4 | 6 | 1 | 3 |
| Finishing | | 2 | 1 | 1 | 0 | 1 | 1 |
| Recycling | 5.0 | n/a | n/a | n/a | n/a | n/a | n/a |
| Overall | | n/a | n/a | n/a | n/a | n/a | n/a |

According to the formula (1) of the first operational rule, the weight of each score item is selected to be 1.0, and the scoring result of each step of the natural environment impact shown in Table 5 is obtained by calculation.

TABLE 5
Natural environment impact

| | Total | Green-house | Waste | | Energy | Chemical | Solid |
|---|---|---|---|---|---|---|---|
| Production flow | score | gas | water | Water | consumption | consumption | waste |
| Raw material production | 7 | 12 | 3 | 10 | 0 | 0 | 14 |
| Fiber production | 1 | 1 | 0 | 0 | 0 | 0 | 1 |
| Yarn production | 5 | 18 | 0 | 0 | 2 | 0 | 10 |
| Fabric production | 2 | 5 | 0 | 0 | 1 | 0 | 1 |
| Dyeing | 4 | 7 | 2 | 4 | 6 | 1 | 3 |
| Finishing | 1 | 2 | 1 | 1 | 0 | 1 | 1 |
| Recycling | 5 | n/a | n/a | n/a | n/a | n/a | n/a |

According to the formula (2) of the second operational rule, the weight of each score item is selected to be 1.0, and the comprehensive score of the natural environment impact is calculated to be 25.

### Embodiment 3—Natural Environmental Impact

For comparison with the embodiment 2 to reflect the objectivity and accuracy of the result obtained with the method and system according to the present invention, in the embodiment 3, the raw material is pure cotton, the production country of each step is China, and the weights are selected to be 1, as in the embodiment 1. The final results are shown in the following Table 6:

TABLE 6
Pure cotton

| Production process | Country | Impact score | Impact |
|---|---|---|---|
| Raw material production | China | 37/100 | |
| Greenhouse gas | | 50 | 56 |
| Water | | 100 | |
| Wastewater | | 54 | |
| Solid waste | | 0 | |
| Chemical consumption | | 1 | |
| Energy consumption | | 13 | |
| Fiber production | China | 2/100 | |
| Yam production | China | 5/100 | |
| Fabric production | China | 2/100 | |
| Dyeing | China | 4/100 | |
| Finishing | China | 1/100 | |
| Recycling | China | 5 | |

### Embodiment 4—Natural Environmental Impact

The raw materials input in the embodiment 4 are full cotton and cotton blended materials. The embodiment has the same production country or district of each step as the embodiment 2, but the weights in the formula (1) of the first operational rule are selected as follows: the weight δ₁ of the greenhouse-gas score item is 1.08; the weight of the wastewater score item is 0.99; the weight δ₃ of the water score item is 1.00; the weight δ₄ of the energy-consumption score item is 0.98; the weight δ₅ of the chemical-consumption score item is 0.97; the weight δ₆ of the solid-waste score item is 0.98. The weights in the formula (2) of the second operational rule are selected as follows: the weight θ₁ of the raw material production step is 1.16; the weight θ₂ of the fiber production step is 0.94; the weight θ₃ of the yarn production step is 0.83; the weight θ₄ of the fabric production step is 0.89; the weight θ₅ of the dyeing step is 1.12; the weight θ₆ of the finishing step is 1.09; the weight θ₇ of the recycling step is 1.00, and the resulting comprehensive score of the natural environmental impact is 43.78.

### Embodiment 5—Human Society Impact and Animal Right Impact

The human society impact and the animal right impact are related to the production implementation country or district of each step. The embodiment 5 has the same production country or district of each step as the embodiments 2 and 4. The weights for the factors of the human society impact are selected as follows: the employee treatment: 1.31; the career development and training: 0.82; the medical security: 0.97; the working environment: 1.23; the occupational safety: 1.24; the community service: 0.72; the transparency: 0.72. The weights of the factors of the animal right impact are selected as follows: the animal experiment and animal abuse: 0.99; others: 1.01. The output results are arranged according to the weights, the factor with a larger weight is listed preferentially, and the output results are shown in the following Table 7.

TABLE 7
Human society impact

| | |
|---|---|
| USA | |
| Employee treatment | Wage: compliance with the minimum wage standard is |
| | low in the Los Angeles area. |
| | Working time: some reports show up to 20 added hours |
| | per week in the Los Angeles area. |
| | Employee welfare: there is no federal law to guarantee |
| | paid sick leave; there is no law to guarantee paid maternity |
| | leave. |
| | Employee right: agricultural workers are not allowed to |
| | constitute or join in guild organizations. |
| | Equal treatment: one report states that 26% of workers |
| | have witnessed or experienced verbal or physical abuse. |
| | Illegal worker: investigations into Latino Americans and |
| | Asians have shown that some organizations traffic |
| | unregistered workers who are forced to work in USA. |
| Occupational safety | No special case. |
| Working environment | Investigations have shown that a third of workers in the |
| | Los Angeles area lack clean drinking water at workplaces. |
| Medical security | No special case. |
| Career development | No special case. |
| and training | |
| Community service | No special case. |
| Transparency | No special case. |
| China | |
| Employee treatment | Wage: a total of 61 wage arrears events are reported from |
| | January to December, 2016. |
| | Working time: forced overtime working is common; work |
| | clearance and rest cannot be guaranteed during busy |
| | periods. |
| | Employee welfare: some reports show that sick leave is |
| | required to be approved by a superior; some reports show |
| | that pregnant workers may be dismissed, and only a few |
| | workers enjoy state-specified maternity leave. |
| | Employee right: worker guild organizations are restricted |
| | by laws strictly. |
| | Equal treatment: different treatment of female employees |
| | is common. |
| | Illegal worker: practice plans cover child labor hiring |
| | situations; |
| Occupational safety | No special case. |
| Working environment | No special case. |
| Medical security | No special case. |
| Career development | No special case. |
| and training | |
| Community service | No special case. |
| Transparency | No special case. |

Animal right impact

| | |
|---|---|
| USA | |
| Others | No special case. |
| Animal experiment | No special case. |
| and animal abuse | |
| China | |
| Others | No special case. |
| Animal experiment | No special case. |
| and animal abuse | |

Result Discussion:

In the embodiments 2 and 3, different raw materials (i.e., the 100% organic cotton in the embodiment 2 and the pure cotton in the embodiment 3), different production regions and the same weight are adopted, and the natural environment impact has different resulting scores of 25 and 56; in the embodiments 2 and 4, different raw materials (i.e., the 100% organic cotton in the embodiment 2 and the full cotton and cotton blended materials in the embodiment 4), different weights and the same production region are adopted, and the natural environment impact also has different resulting scores of 25 and 43.78.

The relevant results are presented in order of importance of the affecting factors in the embodiment 5.

The expert team performs the open questionnaire assessment on the reliability of the results of the embodiments 2 to 5. The expert team includes 5 university professors from Germany, Japan and China, 3 non-governmental organizations specializing in environmental-protection related projects, and 4 global textile garment companies. The assessment results affirm that the results of the embodiments 2 to 5 are reliable and objective, and the obtained values objectively reflect the ecological impact generated by the corresponding raw materials and the country where the production is implemented.

Although the present invention has been described above with reference to the embodiments of the method and system for estimating the ecological impact of the textile fabric production, as well as the computer-readable storage medium, it is conceivable that those skilled in the art can derive many variations, and thus, the variations easily conceived by those skilled in the art are recognized as a part of present invention. The scope of the present invention is defined in the attached claims.

1. A method for estimating an ecological impact of textile fabric production, the ecological impact comprising a natural environment impact, the method comprising:
inputting composition of a textile fabric and a name of region where one or more steps of the textile fabric production are implemented;
calling corresponding data from a database according to the input composition and the input name of region; and
obtaining a score of the natural environment impact of the one or more steps of the textile fabric production according to a predetermined first operational rule and the data.

2. The method according to claim 1, further comprising determining a comprehensive score of the natural environment impact of the textile fabric production from the obtained scores of the natural environment impact of the plural steps according to a predetermined second operational rule.

3. The method according to claim 1, wherein the first operational rule comprises a formula EIᵢ=Σ(GW+WW+WC+EC+CM+SW), wherein EIᵢ denotes the score of the natural environment impact of the ith step, GW denotes a greenhouse gas score item, WW denotes a wastewater score item, WC denotes a water score item, EC denotes an energy consumption score item, CM denotes a chemical consumption score item, and SW denotes a solid waste score item; wherein the score of the natural environment impact of the ith step is a weighted average of the score items.

4. The method according to claim 2, wherein the second operational rule comprises a formula EI₀=Σᵢ₌₁⁷EIᵢ, wherein EI₀ denotes the comprehensive score of the natural environment impact, EI₁ denotes a raw material production step score item, EI₂ denotes a fiber production step score item, EI₃ denotes a yarn production step score item, EI₄ denotes a fabric production step score item, EI₅ denotes a dyeing step score item, EI₆ denotes a finishing step score item, and Eh denotes a recycling step score item.

5. The method according to claim 3, wherein the first operational rule further comprises selecting a set of predetermined weights consisting of (δₙ, n=1,2,3,4,5,6) to be applied to the score terms in the formula of the first operational rule respectively, wherein δₙ ranges from 0.1 to 2.0.

6. The method according to claim 4, wherein the second operational rule further comprises selecting a set of predetermined weights consisting of (θₙ, n=1,2,3,4,5,6,7) to be applied to the score terms in the formula of the second operational rule respectively, wherein θₙ ranges from 0.1 to 2.0.

7. The method according to claim 1, wherein the ecological impact further comprises a human society impact and/or an animal right impact.

8. The method according to claim 7, further comprising a step of estimating the human society impact, the step comprising: calling a corresponding report in the database according to the input name of region, and outputting a title of the corresponding report as an estimation result.

9. The method according to claim 7, further comprising a step of estimating the animal right impact, the step comprising: calling a corresponding report in the database according to the input name of region, and outputting a title of the corresponding report as an estimation result.

10. The method according to claim 8, wherein the estimation result of the human society impact comprises employee treatment, career development and training, medical security, a working environment, occupational safety, community services and transparency.

11. The method according to claim 9, wherein the estimation result of the animal right impact comprises an animal experiment and animal abuse.

12. The method according to claim 1, wherein when the corresponding data is not called from the database, an average of all regions is used to replace the missing data.

13. The method according to claim 3, wherein before the data is substituted into the formula of the first operational rule for calculation, the data is standardized.

14. The method according to claim 2, further comprising: converting the obtained comprehensive score of the natural environment impact into a standard score.

15. The method according to claim 1, wherein the database contains data of the ecological impact of each step of the textile fabric production at different regions and may be updated via a network server.

16. The method according to claim 1, wherein the textile fabric comprises a textile fabric made of a single raw material and a textile fabric mixed of a plurality of raw materials.

17. A system for estimating an ecological impact of textile fabric production, the ecological impact comprising a natural environment impact, the system comprising:
an input module for inputting composition of a textile fabric and a name of region where one or more steps of the textile fabric production are implemented;
a processor configured to perform the following operations:
calling corresponding data from a database according to the input composition and the input name of region; and
performing an operation according to a predetermined first operational rule and the data, so as to obtain a score of the natural environment impact of the one or more steps of the textile fabric production; and
an output module for outputting the score of the natural environment impact.

18. A computer-readable storage medium with computer instructions stored thereon, characterized in that the instructions, when executed by a processor, implement the following steps:
calling corresponding data from a database according to input composition of a textile fabric and an input name of region where one or more steps of textile fabric production are implemented; and
performing an operation according to a predetermined first operational rule and the data, so as to obtain a score of the natural environment impact of the one or more steps of the textile fabric production.
